(19) United States
(12) Patent Application Publication
(10) Pub. No.: US 2019/0316914 A1
(43) Pub. Date: Oct. 17, 2019

(54) SPEED-BUMP BASED LOCALIZATION ENHANCEMENT

(71) Applicant: Faraday&Future Inc., Gardena, CA (US)

(72) Inventors: Kwang Keun J. SHIN, Torrance, CA (US); Hong S. BAE, Torrance, CA (US)

(21) Appl. No.: 15/955,366

(22) Filed: Apr. 17, 2018

(51) Int. Cl. G01C 21/30; G01S 19/49; B60W 40/06

(52) U.S. Cl. CPC G01C 21/30; G01S 19/49; B60W 2550/406; B60W 2510/22; B60W 2550/402; B60W 40/06

(57) ABSTRACT

The present disclosure is related to enhanced vehicle localization using speed bump detection. In some examples, a vehicle of the present disclosure can estimate its location using GNSS and/or dead reckoning techniques. However, especially in scenarios where GNSS reception is poor, the uncertainty in the vehicle's location can be too large to accurately control the vehicle in a fully- or partially-autonomous driving mode. To reduce uncertainty in the vehicle's location, the vehicle can locate one or more features included in map information received by or stored on the vehicle. In some embodiments, a speed bump is included in the map information. The speed bump can be detected by one or more sensors, such as a motion sensor or one or more suspension level sensors, of the vehicle. The vehicle can determine its location using the detected position of the speed bump and the map information.

### FIELD OF THE DISCLOSURE

This relates generally to vehicle localization for autonomous vehicle navigation, partially autonomous vehicle navigation, and driver assistance systems.

### BACKGROUND OF THE DISCLOSURE

Vehicles, especially automobiles, partially autonomous automobiles, and automobiles including driver assistance systems, increasingly include various systems and sensors for determining the vehicle's location. Current localization techniques for vehicles include Global Positioning Systems (GPS) and dead reckoning. GPS techniques (including Global Navigation Satellite Systems (GNSS)), however, can result in some uncertainty under certain conditions. For example, GPS localization can be inaccurate because of signal blockage (e.g., due to tall buildings, being in a tunnel or parking garage), signal reflections off of buildings, or atmospheric conditions. Moreover, dead reckoning techniques can be imprecise and can accumulate error as the vehicle travels. Accurate localization of a vehicle, however, is critical to achieve safe autonomous vehicle navigation. Therefore, a solution to enhance localization techniques for autonomous vehicle navigation can be desirable.

### SUMMARY

The present invention is directed to vehicle localization for autonomous vehicle navigation, partially autonomous vehicle navigation, and driver assistance systems. In some embodiments, a vehicle includes multiple systems for determining a vehicle's pose (location and orientation), such as GPS, dead reckoning systems, HD map systems, and a number of localization sensors (e.g., LIDAR, cameras, ultrasonic sensors, etc.). The vehicle can estimate its location using one or more of a GPS system and/or dead reckoning techniques. However, in some situations when GPS is unavailable or unreliable (e.g., due to poor signal reception caused by buildings near the vehicle or when the vehicle is inside a parking structure), the vehicle's estimated location can become more uncertain. Further, dead reckoning techniques can produce errors in estimated vehicle location as the vehicle continues to move.

In some embodiments, the vehicle uses map information to refine its estimated location to reduce position errors. The map information can be downloaded using a wireless or wired connection to a server, another vehicle, or another data source or stored on the vehicle. The map information includes a number of features that can be detected by the vehicle using cameras, LIDAR, ultrasonic sensors, and other sensors included in the vehicle and matched to the features of the map information. The vehicle can determine its location relative to one or more detected features and, based on the sensor information and the map information, obtain an estimated pose of the vehicle relative to the map information. In this way, the vehicle can obtain an improved estimated location relative to the estimated location obtained using GPS and dead reckoning alone.

In some embodiments, the map information includes the location of one or more speed bumps. Driving over the speed bump causes the vehicle to accelerate upwards and downwards. This acceleration can be detected by an IMU (inertial measurement unit) capable of measuring vehicle acceleration in three axis and vehicle pitch and/or one or more suspension level sensors configured to measure activity at the vehicle's suspension system, such as driving over a speed bump. The vehicle uses these data to determine its location relative to the speed bump and can therefore determine its location within the map information based on the speed bump's location within the map.

### BRIEF DESCRIPTION OF THE DRAWINGS

FIG. 1 illustrates a system block diagram of a vehicle control system according to examples of the disclosure.

FIG. 2 illustrates a vehicle updating its estimated pose based on map information and detection of a speed bump according to examples of the disclosure.

FIG. 3A illustrates a vehicle collecting data from a plurality of sensors as it drives over a speed bump according to examples of the disclosure.

FIG. 3B illustrates data collected by one or more sensors included in a vehicle according to examples of the disclosure

FIG. 4 illustrates a process for localizing a vehicle based on map information and sensor information according to examples of the disclosure.

### DETAILED DESCRIPTION

In the following description, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to autonomous driving, partially autonomous driving, and/or driver assistance systems.

The present invention is directed to vehicle localization for autonomous vehicle navigation, partially autonomous vehicle navigation, and driver assistance systems. In some embodiments, a vehicle includes multiple systems for determining a vehicle's pose (location and orientation), such as GPS, dead reckoning systems, HD map systems, and a number of localization sensors (e.g., LIDAR, cameras, ultrasonic sensors, etc.). The vehicle can estimate its location using one or more of a GPS system and/or dead reckoning techniques. However, in some situations when GPS is unavailable or unreliable (e.g., due to poor signal reception caused by buildings near the vehicle or when the vehicle is inside a parking structure), the vehicle's estimated location can become more uncertain. Further, dead reckoning techniques can produce errors in estimated vehicle location as the vehicle continues to move.

In some embodiments, the vehicle uses map information to refine its estimated location to reduce position errors. The map information can be downloaded using a wireless or wired connection to a server, another vehicle, or another data source or stored on the vehicle. The map information includes a number of features that can be detected by the vehicle using cameras, LIDAR, ultrasonic sensors, and other sensors included in the vehicle and matched to the features of the map information. The vehicle can determine its location relative to one or more detected features and, based on the sensor information and the map information, obtain an estimated pose of the vehicle relative to the map information. In this way, the vehicle can obtain an improved estimated location relative to the estimated location obtained using GPS and dead reckoning alone.

In some embodiments, the map information includes the location of one or more speed bumps. Driving over the speed bump causes the vehicle to accelerate upwards and downwards. This acceleration can be detected by an IMU (inertial measurement unit) capable of measuring vehicle acceleration in three axis and vehicle pitch and/or one or more suspension level sensors configured to measure activity at the vehicle's suspension system, such as driving over a speed bump. The vehicle uses these data to determine its location relative to the speed bump and can therefore determine its location within the map information based on the speed bump's location within the map.

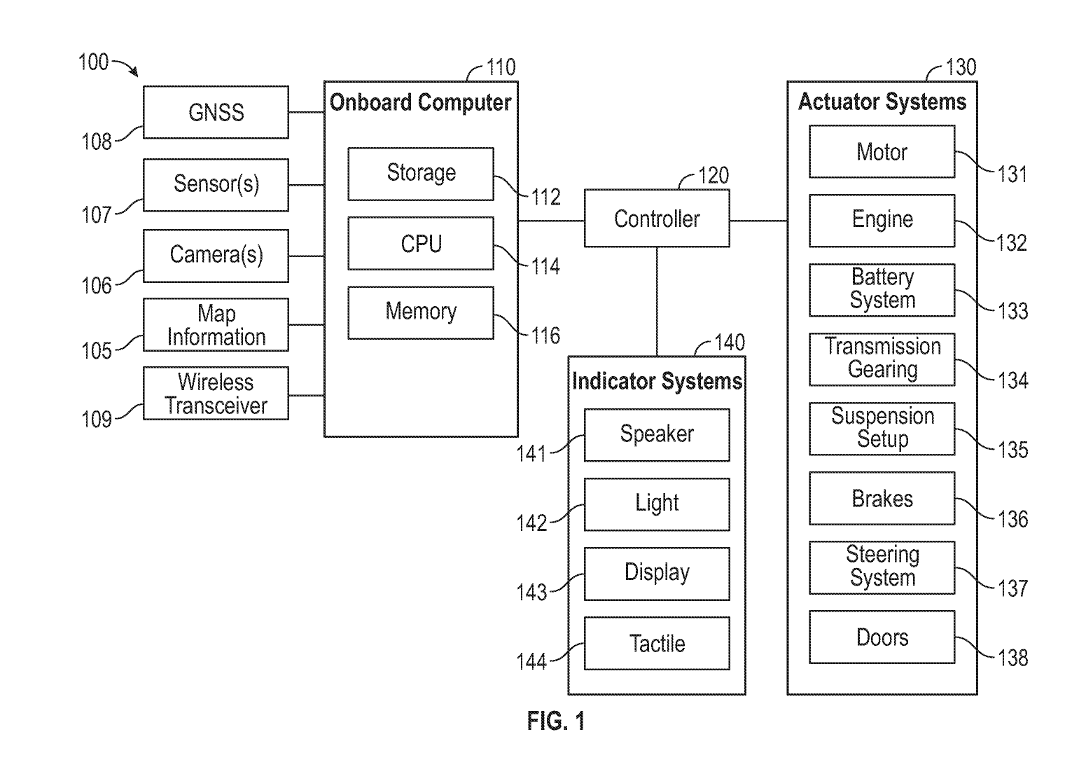

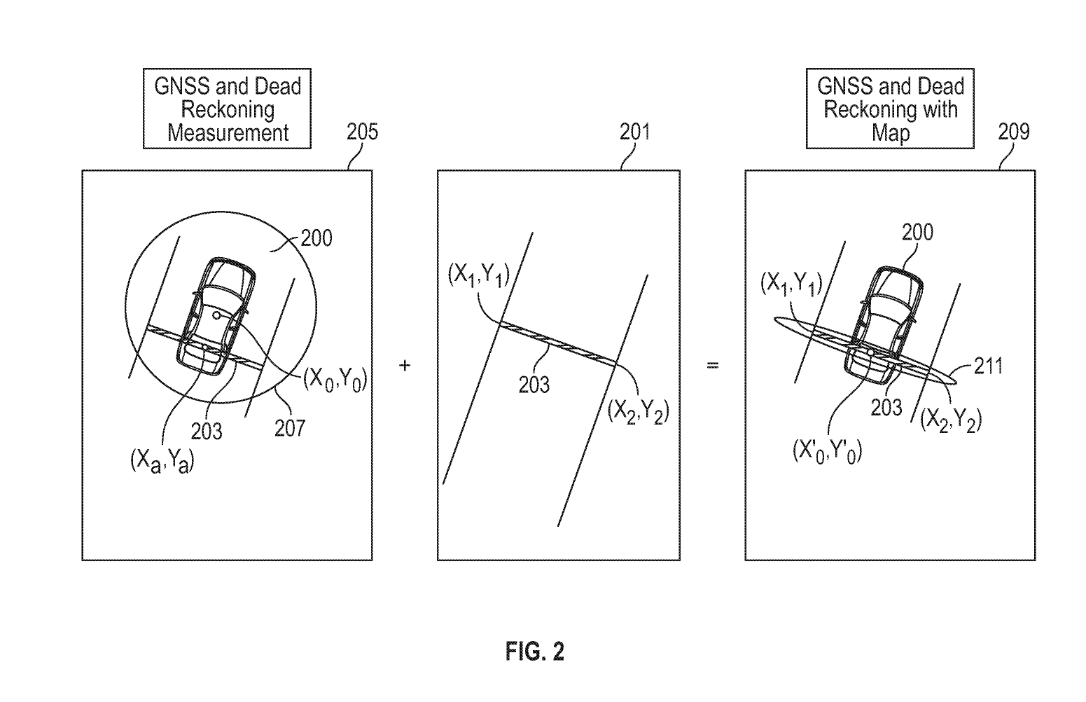

FIG. 1 illustrates a system block diagram of vehicle control system 100 according to examples of the disclosure. Vehicle control system 100 can perform any of the methods described with reference to FIGS. 2-4 below. System 100 can be incorporated into a vehicle, such as a consumer automobile. Other example vehicles that may incorporate the system 100 include, without limitation, airplanes, boats, or industrial automobiles. In some embodiments, vehicle control system 100 includes one or more cameras 106 capable of capturing image data (e.g., video data) for determining various features of the vehicle's surroundings. Vehicle control system 100 can also include one or more other sensors 107 (e.g., radar, ultrasonic, LIDAR, IMU, suspension level sensor, etc.) capable of detecting various features of the vehicle's surroundings, and a Global Navigation Satellite System (GNSS) receiver 108 capable of determining the location of the vehicle. In some embodiments, sensors 107 further include dead reckoning sensors such as wheel sensors and speed sensors whose data can be used to estimate vehicle movement. It should be appreciated that GNSS receiver 108 can be a Global Positioning System (GPS) receiver, BeiDou receiver, Galileo receiver, and/or a GLONASS receiver. The features of the vehicle's surroundings, such as a speed bump detected by an IMU or a suspension level sensor, can be used in localizing the vehicle relative to map information 105. Vehicle control system 100 can also receive (e.g., via an internet connection) feature map information via a map information interface 105 (e.g., a cellular internet interface, a Wi-Fi internet interface, etc.). In some examples, vehicle control system 100 can further include a wireless transceiver 109 configured for receiving information from other vehicles and/or from smart infrastructure.

Vehicle control system 100 further includes an on-board computer 110 that is coupled to the cameras 106, sensors 107, GNSS receiver 108, map information interface 105, and wireless transceiver 109 and that is capable of receiving outputs from the sensors 107, the GNSS receiver 108, map information interface 105, and wireless transceiver 109. The on-board computer 110 is capable of estimating the location of the vehicle based on one or more of sensor measurements, map information, GNSS information, and dead reckoning techniques. On-board computer 110 includes one or more of storage 112, memory 116, and a processor 114. Processor 114 can perform any of the methods described below with reference to FIGS. 2-4. Additionally, storage 112 and/or memory 116 can store data and instructions for performing any of the methods described with reference to FIGS. 2-4. Storage 112 and/or memory 116 can be any non-transitory computer readable storage medium, such as a solid-state drive or a hard disk drive, among other possibilities.

In some embodiments, the vehicle control system 100 is connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 controls, via controller 120, one or more of these actuator systems 130 during vehicle operation; for example, to control the vehicle during fully or partially autonomous driving operations, using the motor 131 or engine 132, battery system 133, transmission gearing 134, suspension setup 135, brakes 136 and/or steering system 137, etc. Actuator systems 130 can also include sensors (e.g., sensors 107, including dead reckoning sensors) that send dead reckoning information (e.g., steering information, speed information, wheel information, etc.) to on-board computer 110 (e.g., via controller 120) to determine the vehicle's location and orientation. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 controls, via controller 120, one or more of these indicator systems 140 to provide visual and/or audio indications, such as an indication that a driver will need to take control of the vehicle, for example.

FIG. 2 illustrates a vehicle 200 updating its estimated pose based on map information 201 and detection of a speed bump 203 according to examples of the disclosure. Vehicle 200 can include the systems illustrated in FIG. 1. Vehicle 200 can be an autonomous vehicle, a partially autonomous vehicle, or can include a driving assistance system that uses the vehicle's estimate of its location. For example, vehicle 200 can estimate its location (e.g., the midpoint of the rear axle of the vehicle) based on GNSS and dead reckoning measurements 205 to obtain an estimated location Xₒ, Yₒ within a range of uncertainty, visually represented here as uncertainty 207. In some embodiments, dead reckoning measurements include measurements of vehicle movement based on wheel sensors, speed sensors, and the like. As shown in FIG. 2, the vehicle's actual location (Xₐ, Yₐ) is included within uncertainty 207 but is not the same as the vehicle's estimated location (Xₒ, Yₒ). This level of uncertainty 207 can be acceptable in some situations, such as operating a navigation system in a driver-operated vehicle. However, in some situations, such as autonomous driving situations, a more precise estimate of vehicle location with a reduced uncertainty in at least one direction can be desired. In these situations and in others, the vehicle can use map information and sensor data including one or more detected map features to localize the vehicle within the map which in turn allows the vehicle to localize itself. That is to say, the vehicle can determine its position relative to one or more features included in the map information using data from one or more of its sensors (e.g., sensors 107).

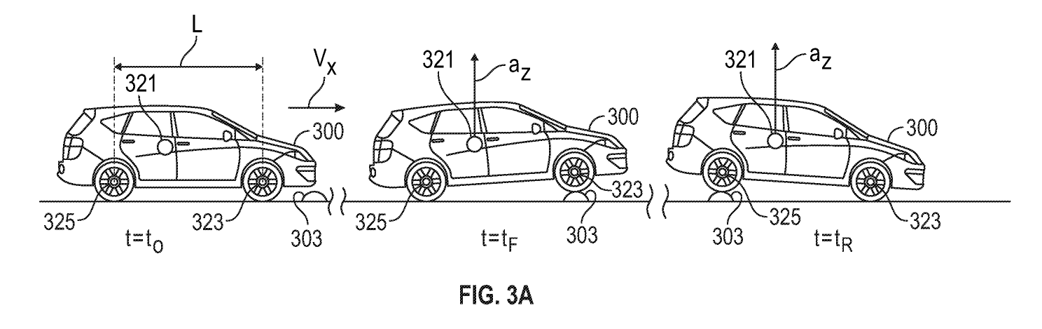

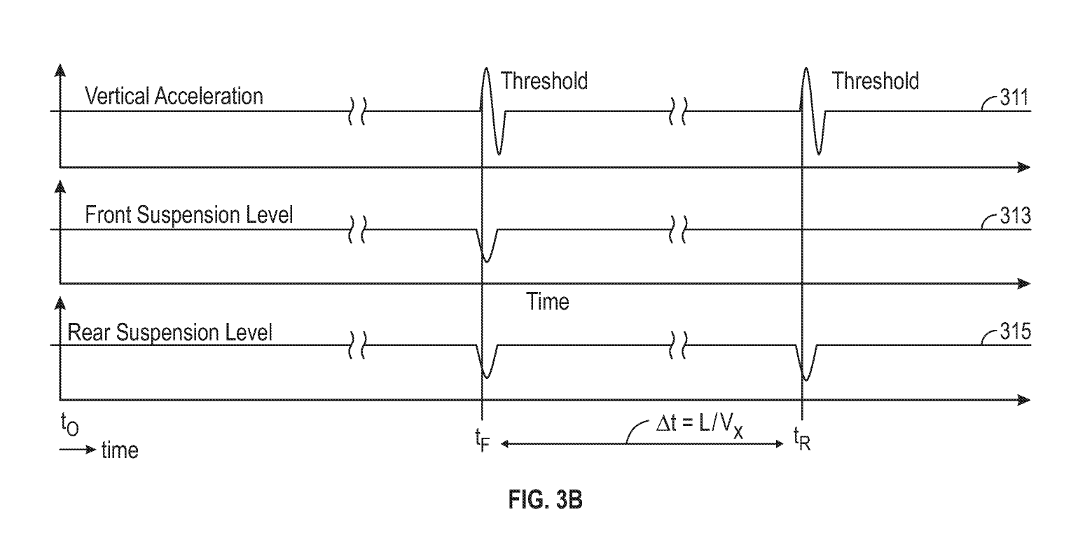

In some embodiments, vehicle 200 has access to map information 201 including the location of a speed bump 203. For example, the speed bump 203 can be defined in the map information by the locations of its ends at (X₁, Y₁) and (X₂, Y₂). While driving, vehicle 200 can detect the speed bump 203 using one or more sensors (e.g., sensors 107), as will be described below with reference to FIG. 3. The vehicle 200 determines its location relative to the speed bump 203 based on the captured sensor data, which allows the vehicle to match or otherwise identify its determined location within the map 201. As shown in FIG. 2, when the vehicle 200 detects the speed bump 203, its estimated position (X′ₒ, Y′ₒ) updates to a location on top of the speed bump. The vehicle's new estimated position may have an associated range of uncertainty, represented here as uncertainty 211. As shown, uncertainty 211 can be smaller than uncertainty 207 in the longitudinal direction, which is the direction of vehicle travel, because the vehicle determined that it traversed over the speed bump but did not necessarily determine its location along the length of the speed bump, for example. For autonomous driving operations, longitudinal error can be more important and/or difficult to determine than lateral error because the vehicle 200 can use cameras, LIDAR, and other sensors to avoid a lateral collision, while there are fewer features in the longitudinal direction (i.e., in the middle of the road in the direction of vehicle travel) for the vehicle to detect and use for localization. In this way, the vehicle 200 obtains an improved estimate of its location by detecting speed bumps 203 included in map information compared to relying on GNSS and dead reckoning alone.

FIG. 3A illustrates a vehicle 300 collecting data from a plurality of sensors 321-325 as it drives over a speed bump 303 according to examples of the disclosure. Vehicle 300 can correspond to one or more of the vehicles discussed above with reference to FIGS. 1 and 2. As shown in FIG. 3A, the vehicle 300 can travel in the x-direction at a velocity Vₓ. When the vehicle 300 drives over the speed bump 303 (e.g., with its front wheels at time t_{F} and with its back wheels at a time t_{R}), the vehicle accelerates in the z-direction at an acceleration a_{z}. Vehicle 300 includes one or more sensors, which can include motion sensor 321, front suspension level sensor 323, and rear suspension level sensor 325. In some embodiments, motion sensor 321 comprises one or more of an accelerometer and an inertial measurement unit (IMU). Although motion sensor 321, front suspension level sensor 323, and rear suspension level sensor 325 are illustrated at particular locations on vehicle 300, it should be understood that alternative sensor locations are possible without departing from the scope of the disclosure. Exemplary sensor data will now be described with reference to FIG. 3B.

FIG. 3B illustrates data 311-315 collected by the one or more sensors included in a vehicle according to examples of the disclosure. For example, data 311 can be collected by motion sensor 321 included in vehicle 300. As shown, the vertical access of data 311 represents vertical acceleration 311 (a_{z}) and the horizontal axis of data represents time. Data 313 can be collected by front suspension level sensor 323 included in vehicle 300. As shown, the vertical axis of data 313 represents the level of the front suspension of the vehicle 300, while the horizontal axis of data represents time. Data 315 can be collected by rear suspension level sensor 325 included in vehicle 300. As shown, the vertical axis of data 313 represents the level of the rear suspension of the vehicle 300, while the horizontal axis of data represents time.

While vehicle 300 is in motion, the sensors 321-325 can detect vertical acceleration (a_{z}) 311, front suspension level 313, and/or rear suspension level 315. At a first time tₒ, the vehicle 300 is driving on flat ground and the sensors 301 do not yet detect speed bump 303 based on the sensor data 311-315. When, at t_{F}, the vehicle 300 drives over speed bump 303 with its front wheels, the sensors 321-325 detect the speed bump based on the vertical acceleration 311 and front suspension level 313. Specifically, the motion sensor 321 detects vertical acceleration 311 and the front suspension level sensor 323 detects the front suspension level 313, for example. When, at t_{R}, the vehicle 300 drives over the speed bump 303 again with its rear wheels, the sensors 321-325 detect the speed bump based on the vertical acceleration 311 and the rear suspension level 315. Specifically, the motion sensor 321 detects vertical acceleration 311 and the rear suspension level sensor 325 detects the rear suspension level 315, for example. The time between driving over the speed bump 303 with the front wheels and driving over the speed bump 303 with the rear wheels, Δt, is equal to the length of the vehicle L divided by the vehicle's longitudinal velocity Vₓ (i.e., the vehicle's velocity in the direction over the speed bump).

The vehicle 300 can update its estimated location after detecting the speed bump 303 with its front wheels and/or after detecting the speed bump 303 with its rear wheels. In some embodiments, the vehicle can have stored on its onboard computer (e.g., onboard computer 110) one or more programs or algorithms for determining that it drove over a speed bump 303 based on sensor data 311-315. For example, the onboard computer can match the sensor data 311-315 to one or more thresholds or training curves to match the data to the data profile expected from a speed bump.

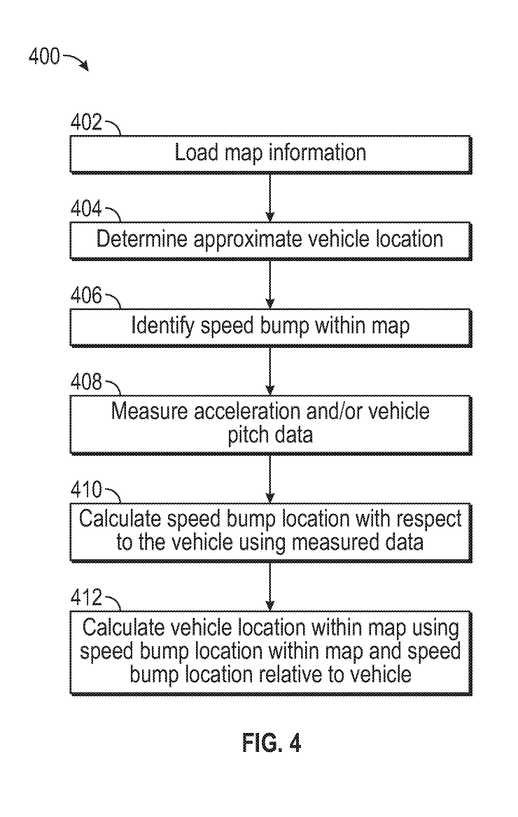

FIG. 4 illustrates a process 400 for localizing a vehicle based on map information and sensor information according to examples of the disclosure. Process 400 can be performed by one or more of the vehicles described above with reference to FIGS. 1-3. At step 402, the map information is loaded. Loading the map information can include one or more of downloading the map information from a third-party source as described above and/or accessing the map information stored on the onboard computer (e.g., onboard computer 110) or another system of the vehicle.

At step 404, the vehicle determines its approximate location. In some embodiments, the vehicle uses techniques such as dead reckoning and/or obtaining a GNSS sample to estimate its location. The estimated location can include a location with an uncertainty as described above with reference to FIG. 2. In some embodiments, the estimated location is obtained by sampling a GNSS sensor measurement in regular or irregular time intervals and updating the estimated location between samples using data from one or more dead reckoning sensors (e.g., sensors 107). In some situations when GNSS reception is poor (e.g., when the vehicle is underground or surrounded by tall buildings), the uncertainty in the vehicle's estimated location can increase compared to situations where GNSS reception is strong.

At step 406, the vehicle identifies a speed bump (e.g., speed bump 203 or speed bump 303) within the map information. Identifying the speed bump within the map information can include determining that the vehicle is within a threshold distance or expected threshold time from driving over the speed bump. The map information can include the coordinates of the speed bump and other information such as additional features proximate to the speed bump or a height and/or expected sensor response of the speed bump. In some embodiments, the speed bump can be defined in the map information based on the locations of its ends, as shown in FIG. 2.

At step 408, the vehicle obtains sensor data, such as the sensor data described above with reference to FIGS. 1-3. The sensor data can include one or more of acceleration or pitch sensed by an IMU or suspension level sensed by a suspension level sensor. Exemplary data from these sensors collected while the vehicle drives over a speed bump are illustrated in FIG. 3.

At step 410, the vehicle calculates the speed bump location with respect to the vehicle based on the sensor data. For example, when the vehicle detects that its front or back wheels are presently driving over the speed bump, it can calculate the distance between a reference point on the vehicle and the speed bump based on a known relative orientation between the reference point and the wheels.

At step 412, the vehicle calculates its location within the map information using the speed bump location within the map and the speed bump location relative to the vehicle. Based on the vehicle's calculated position with respect to the speed bump, the speed bump's position within the map, and known dimensions of the vehicle, the vehicle localizes itself. As described above with reference to FIG. 2, in some embodiments, the vehicle's estimated location based on speed bump localization can include a lateral error that is larger than the vehicle's longitudinal error. However, for the purposes of operating the vehicle in an autonomous driving mode without collision, the vehicle can rely on sensors (e.g., range sensors, LIDAR, ultrasonics, cameras, etc.) to detect objects in the lateral direction to avoid a collision and/or decrease lateral uncertainty.

It should be understood that the steps of process 400 can be performed in an order different from the order in which they are described herein without departing from the scope of the disclosure. Further, steps can be repeated, skipped, or performed simultaneously without departing from the scope of the disclosure.

Thus, the disclosure above provides ways of enhancing localization techniques using speed bumps for safe autonomous vehicle navigation.

Therefore, according to the above, the disclosure relates to a system for use in a vehicle, the system comprising: one or more sensors; one or more processors operatively coupled to the one or more sensors; and a memory including instructions, which when executed by the one or more processors, cause the one or more processors to perform a method comprising the steps of: loading map information, the map information comprising a location of a speed bump within a map; receiving motion data from the one or more sensors; calculating a location of the speed bump relative to the vehicle based on the motion data; and calculating a location of the vehicle within the map based on the location of the speed bump within the map and the location of the speed bump relative to the vehicle. Additionally or alternatively, in some examples the one or more sensors include an accelerometer. Additionally or alternatively, in some examples the one or more sensors include an inertial measurement unit (IMU). Additionally or alternatively, in some examples the system further comprises a global navigation satellite system (GNSS) receiver, wherein: the method further comprises the step of estimating a location of the vehicle using data from the GNSS receiver, and calculating the location of the vehicle within the map based on the location of the speed bump within the map and the location of the speed bump relative to the vehicle reduces an uncertainty of the estimated location of the vehicle. Additionally or alternatively, in some examples the system further comprises one or more dead reckoning sensors, wherein: the method further comprises the step of estimating a location of the vehicle using data from the dead reckoning sensors, and calculating the location of the vehicle within the map based on the location of the speed bump within the map and the location of the speed bump relative to the vehicle reduces an uncertainty of the estimated location of the vehicle. Additionally or alternatively, in some examples the one or more sensors include one or more suspension level sensors positioned at one or more of a front axle of the vehicle and a rear axle of the vehicle, wherein the location of the speed bump is calculated based on data from the one or more suspension level sensors.

Some examples of the disclosure relate to a non-transitory computer-readable medium including instructions, which when executed by one or more processors, cause the one or more processors to perform a method comprising: loading map information, the map information comprising a location of a speed bump within a map; receiving motion data from one or more sensors included in a vehicle system; calculating a location of the speed bump relative to the vehicle based on the motion data; and calculating a location of the vehicle within the map based on the location of the speed bump within the map and the location of the speed bump relative to the vehicle. Additionally or alternatively, in some examples the one or more sensors include an accelerometer. Additionally or alternatively, in some examples the one or more sensors include an inertial measurement unit (IMU). Additionally or alternatively, in some examples the vehicle system further comprises a global navigation satellite system (GNSS) receiver, the method further comprises the step of estimating a location of the vehicle using data from the GNSS receiver, and calculating the location of the vehicle within the map based on the location of the speed bump within the map and the location of the speed bump relative to the vehicle reduces an uncertainty of the estimated location of the vehicle. Additionally or alternatively, in some examples the vehicle system further comprises one or more dead reckoning sensors, the method further comprises the step of estimating a location of the vehicle using data from the dead reckoning sensors, and calculating the location of the vehicle within the map based on the location of the speed bump within the map and the location of the speed bump relative to the vehicle reduces an uncertainty of the estimated location of the vehicle. Additionally or alternatively, in some examples the one or more sensors of the vehicle system include one or more suspension level sensors positioned at one or more of a front axle of the vehicle and a rear axle of the vehicle, wherein the location of the speed bump is calculated based on data from the one or more suspension level sensors.

Some examples of the disclosure are related to a method comprising: loading map information, the map information comprising a location of a speed bump within a map; receiving motion data from one or more sensors included in a vehicle system; calculating a location of the speed bump relative to the vehicle based on the motion data; and calculating a location of the vehicle within the map based on the location of the speed bump within the map and the location of the speed bump relative to the vehicle. Additionally or alternatively, in some examples the one or more sensors include an accelerometer. Additionally or alternatively, in some examples the one or more sensors include an inertial measurement unit (IMU). Additionally or alternatively, in some examples the method further comprises estimating a location of the vehicle using data from a global navigation satellite system (GNSS) receiver included in the vehicle system, wherein: calculating the location of the vehicle within the map based on the location of the speed bump within the map and the location of the speed bump relative to the vehicle reduces an uncertainty of the estimated location of the vehicle. Additionally or alternatively, in some examples the method further comprises estimating a location of the vehicle using data from one or more dead reckoning sensors included in the vehicle system, wherein: calculating the location of the vehicle within the map based on the location of the speed bump within the map and the location of the speed bump relative to the vehicle reduces an uncertainty of the estimated location of the vehicle. Additionally or alternatively, in some examples the one or more sensors of the vehicle system include one or more suspension level sensors positioned at one or more of a front axle of the vehicle and a rear axle of the vehicle, wherein the location of the speed bump is calculated based on data from the one or more suspension level sensors.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A system for use in a vehicle, the system comprising:
one or more sensors;
one or more processors operatively coupled to the one or more sensors; and
a memory including instructions, which when executed by the one or more processors, cause the one or more processors to perform a method comprising the steps of:
loading map information, the map information comprising a location of a speed bump within a map;
receiving motion data from the one or more sensors;
calculating a location of the speed bump relative to the vehicle based on the motion data; and
calculating a location of the vehicle within the map based on the location of the speed bump within the map and the location of the speed bump relative to the vehicle.

2. The system of claim 1, wherein the one or more sensors include an accelerometer.

3. The system of claim 1, wherein the one or more sensors include an inertial measurement unit (IMU).

4. The system of claim 1, further comprising:
a global navigation satellite system (GNSS) receiver, wherein:
the method further comprises the step of estimating a location of the vehicle using data from the GNSS receiver, and
calculating the location of the vehicle within the map based on the location of the speed bump within the map and the location of the speed bump relative to the vehicle reduces an uncertainty of the estimated location of the vehicle.

5. The system of claim 1, further comprising:
one or more dead reckoning sensors, wherein:
the method further comprises the step of estimating a location of the vehicle using data from the dead reckoning sensors, and
calculating the location of the vehicle within the map based on the location of the speed bump within the map and the location of the speed bump relative to the vehicle reduces an uncertainty of the estimated location of the vehicle.

6. The system of claim 1, wherein the one or more sensors include one or more suspension level sensors positioned at one or more of a front axle of the vehicle and a rear axle of the vehicle, wherein the location of the speed bump is calculated based on data from the one or more suspension level sensors.

7. A non-transitory computer-readable medium including instructions, which when executed by one or more processors, cause the one or more processors to perform a method comprising:
loading map information, the map information comprising a location of a speed bump within a map;
receiving motion data from one or more sensors included in a vehicle system;
calculating a location of the speed bump relative to the vehicle based on the motion data; and
calculating a location of the vehicle within the map based on the location of the speed bump within the map and the location of the speed bump relative to the vehicle.

8. The non-transitory computer-readable medium of claim 7, wherein the one or more sensors include an accelerometer.

9. The non-transitory computer-readable medium of claim 7, wherein the one or more sensors include an inertial measurement unit (IMU).

10. The non-transitory computer-readable medium of claim 7, wherein:
the vehicle system further comprises a global navigation satellite system (GNSS) receiver,
the method further comprises the step of estimating a location of the vehicle using data from the GNSS receiver, and
calculating the location of the vehicle within the map based on the location of the speed bump within the map and the location of the speed bump relative to the vehicle reduces an uncertainty of the estimated location of the vehicle.

11. The non-transitory computer-readable medium of claim 7, wherein:
the vehicle system further comprises one or more dead reckoning sensors,
the method further comprises the step of estimating a location of the vehicle using data from the dead reckoning sensors, and
calculating the location of the vehicle within the map based on the location of the speed bump within the map and the location of the speed bump relative to the vehicle reduces an uncertainty of the estimated location of the vehicle.

12. The non-transitory computer-readable medium of claim 7, wherein the one or more sensors of the vehicle system include one or more suspension level sensors positioned at one or more of a front axle of the vehicle and a rear axle of the vehicle, wherein the location of the speed bump is calculated based on data from the one or more suspension level sensors.

13. A method comprising:
loading map information, the map information comprising a location of a speed bump within a map;
receiving motion data from one or more sensors included in a vehicle system;
calculating a location of the speed bump relative to the vehicle based on the motion data; and
calculating a location of the vehicle within the map based on the location of the speed bump within the map and the location of the speed bump relative to the vehicle.

14. The method of claim 13, wherein the one or more sensors include an accelerometer.

15. The method of claim 13, wherein the one or more sensors include an inertial measurement unit (IMU).

16. The method of claim 13, further comprising:
estimating a location of the vehicle using data from a global navigation satellite system (GNSS) receiver included in the vehicle system, wherein:
calculating the location of the vehicle within the map based on the location of the speed bump within the map and the location of the speed bump relative to the vehicle reduces an uncertainty of the estimated location of the vehicle.

17. The method of claim 13, further comprising:
estimating a location of the vehicle using data from one or more dead reckoning sensors included in the vehicle system, wherein:
calculating the location of the vehicle within the map based on the location of the speed bump within the map and the location of the speed bump relative to the vehicle reduces an uncertainty of the estimated location of the vehicle.

18. The method of claim 13, wherein the one or more sensors of the vehicle system include one or more suspension level sensors positioned at one or more of a front axle of the vehicle and a rear axle of the vehicle, wherein the location of the speed bump is calculated based on data from the one or more suspension level sensors.
